(19) United States
(12) Patent Application Publication
(10) Pub. No.: US 2026/0296075 A1
(43) Pub. Date: Oct. 1, 2026

(54) PRINTING APPARATUS AND PRINTING METHOD

(71) Applicant: SEIKO EPSON CORPORATION, Tokyo (JP)

(72) Inventor: Kazuki TSUCHIDA, Shiojiri (JP)

(21) Appl. No.: 19/577,464

(22) Filed: Mar. 25, 2026

(30) Foreign Application Priority Data
Mar. 27, 2025 (JP) 2025-053162

(51) Int. Cl. B41J 29/13; B41J 2/045; B41J 3/46; G01C 3/02

(52) U.S. Cl. CPC B41J 29/13; B41J 2/04556; B41J 2/04586; B41J 3/46; G01C 3/02

(57) ABSTRACT

A printing apparatus according to an aspect of the present disclosure includes a housing having an openable/closable first cover, a support section configured to support a medium, a print head configured to perform printing on the medium based on a distance between the print head and the support section, and a distance detection section configured to detect the distance. The distance detection section executes detection of the distance when the first cover is closed.

### CROSS-REFERENCE TO RELATED APPLICATION

The present application is based on, and claims priority from JP Application Serial Number 2025-053162, filed Mar. 27, 2025, the disclosure of which is hereby incorporated by reference herein in its entirety.

### BACKGROUND

### 1. Technical Field

The present disclosure relates to a printing apparatus and a printing method.

### 2. Related Art

JP-A-2024-102879 describes a printing apparatus including a medium support section having a support surface that supports at least a printing region of a medium, and a head capable of ejecting liquid onto the medium supported by the support surface. A printing apparatus described in JP-A-2024-102879 includes, in order to suppress the medium from becoming contaminated with liquid when the medium is mounted on a support surface, a maintenance section that performs maintenance on a head, and a maintenance cover that can cover a side of the maintenance section in a direction in which the head is able to face the maintenance section.

Meanwhile, in order to make a printing apparatus correspond to printing on a medium having a non-planar printing region, information on a distance between the medium and a support section of the medium is required before execution of printing. However, since the printing apparatus described in JP-A-2024-102879 is based on a premise that a printing region of a medium is planar, there is room for improvement in terms of efficiency of printing when the printing apparatus is to perform printing on a medium having a non-planar printing region.

Therefore, it is desirable to provide a printing apparatus capable of efficiently performing printing even on a medium having a non-planar printing region in which information on a distance between the medium and a support section of the medium is necessary at the time of printing execution.

### SUMMARY

A printing apparatus according to an aspect of the present disclosure includes a housing having an openable/closable first cover, a support section configured to support a medium, a print head configured to perform printing on the medium based on a distance between the print head and the support section, and a distance detection section configured to detect the distance, in which the distance detection section executes detection of the distance when the first cover is closed.

A printing method according to an aspect of the present disclosure includes executing, by a printing apparatus including a housing having an openable/closable first cover, a support section configured to support a medium, and a print head configured to perform printing on the medium based on a distance between the print head and the support section, detection of the distance when the first cover is closed.

### BRIEF DESCRIPTION OF THE DRAWINGS

FIG. 1 is a schematic perspective view showing a configuration example of a printing apparatus according to an embodiment.

FIG. 2 is a functional block diagram of a configuration example of the printing apparatus according to the embodiment.

FIG. 3 is a flowchart for describing an example of distance detection processing executed in the printing apparatus of FIGS. 1 and 2.

FIG. 4 is a flowchart showing an example of cover opening interrupt processing executed in the printing apparatus of FIGS. 1 and 2.

FIG. 5 is a flowchart for describing an example of panel operation interrupt processing executed in the printing apparatus of FIGS. 1 and 2.

FIG. 6 is a flowchart for describing an example of print data reception interrupt processing executed in the printing apparatus of FIGS. 1 and 2.

FIG. 7 is a flowchart for describing an example of printing processing executed in the printing apparatus of FIGS. 1 and 2.

FIG. 8 is a diagram showing an example of the hardware configuration of a device.

### DESCRIPTION OF EMBODIMENTS

Hereinafter, embodiments of the present disclosure will be described with reference to the drawings. Each drawing is only an example describing the embodiment of the present disclosure. In addition, not all of the components described in the embodiment of the present disclosure are essential components of the present disclosure.

### EMBODIMENT

### Configuration Example of Printing Apparatus

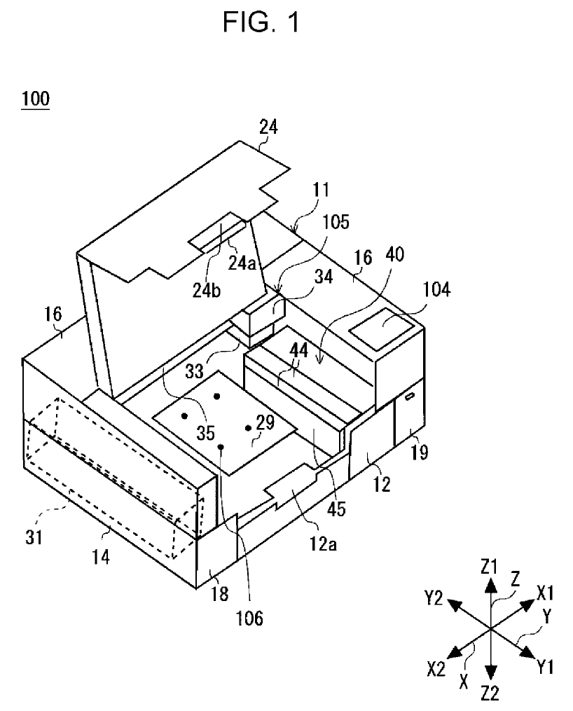

A configuration example of a printing apparatus according to the present embodiment will be described with reference to FIG. 1. FIG. 1 is a schematic perspective view showing a configuration example of the printing apparatus according to the present embodiment.

In the following description, a direction intersecting (for example, orthogonal to) a vertical direction Z is referred to as a width direction X, and a direction intersecting the vertical direction Z and the width direction X is referred to as a front-rear direction Y. One direction in the width direction X is referred to as a first width direction X1, and the other direction in the width direction X is referred to as a second width direction X2. One direction in the front-rear direction Y is referred to as a front side Y1, and the other direction in the front-rear direction Y is referred to as a rear side Y2. An upper side of the vertical direction Z is referred to as an upper side Z1, and a lower side of the vertical direction Z is referred to as a lower side Z2. The width direction X corresponds to an example of a first direction. The front-rear direction Y corresponds to an example of a second direction. The vertical direction Z corresponds to an example of a third direction.

As shown in FIG. 1, a printing apparatus 100 according to the present embodiment can include a housing 11, a support section 29 that supports a medium inside the housing 11, and a print head 33 that performs printing. The support section 29 can also be referred to as a platen.

The housing 11 is a housing that surrounds the outside of the printing apparatus 100 and constitutes an exterior. The housing 11 may have a rectangular parallelepiped shape as shown in FIG. 1, but may have another shape. The housing 11 includes a front surface 12 facing the front side Y1. The housing 11 includes a rear surface facing the rear side Y2. The housing 11 includes a left side surface 14 facing the second width direction X2. The housing 11 includes a right side surface facing the first width direction X1. The housing 11 includes a top surface 16 facing the upper side Z1. The housing 11 includes a bottom surface facing the lower side Z2.

The housing 11 is configured to accommodate various members included in the printing apparatus 100, such as the support section 29, the print head 33, and a distance detection section 106.

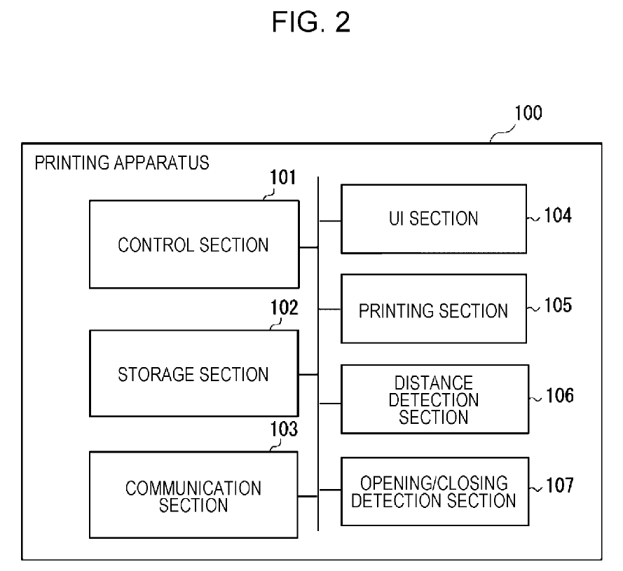

The housing 11 includes an openable/closable first cover 24 configured to be integrated with, for example, the top surface 16 and the front surface 12 of the housing 11 when the housing 11 is closed. That is, the first cover 24 is provided across the top surface 16 and the front surface 12 so as to be openable/closable with respect to the housing 11. In addition, the first cover 24 may include a gripping section 24b that is grippable by a user. The first cover 24 is disposed so as to expose a support surface of the support section 29 in an open state. The first cover 24 can include, for example, a convex engaging section 24a that engages with a concave engaging section 12a formed in a portion of the front surface 12 in a closed state. In addition, the printing apparatus 100 may be provided with an opening/closing detection section 107 shown in FIG. 2, which will be described later, so that opening and closing of the first cover 24 can be detected.

The support section 29 supports a medium on which printing is performed in a printing region. Therefore, the support section 29 may be referred to as a medium support section. The support section 29 has a contact surface with the medium as a support surface. Of course, in a case where the medium has a non-planar surface, the medium does not contact the support surface at all surfaces. The support surface is a surface facing the upper side Z1.

The support surface of the support section 29 is a surface that supports at least a portion of the medium, but may support a portion of the printing region or may support the entire printing region, depending on the shape of the medium. In addition, the support section 29 may not directly support the medium in the entire printing region, and may support the medium only in a non-printing region. In addition, the shape of the support surface need not be planar. For example, the support section 29 may have a shape for gripping the medium in accordance with the shape of the medium. Alternatively, the support section 29 may be provided with a plurality of types of attachments capable of gripping media of respective shapes so as to be compatible with media of various shapes, and the attachments may be replaced in accordance with the media.

Further, the support section 29 may be a member directly or indirectly fixed to the housing 11. That is, the support section 29 may be configured to accommodate the medium with the first cover 24 opened, without including a mechanism such as horizontally moving parallel to the support surface. Further, the support section 29 may be configured such that a position of the support surface with respect to the vertical direction Z can be adjusted.

However, for example, a configuration may be adopted in which the support section 29 is configured to be movable toward the front surface 12 side, when the medium is set, the medium is set on the support section 29 that has been moved to an outside of the front surface 12, and thereafter the support section 29 is moved into the housing 11.

In addition, the printing apparatus 100 includes a liquid supply section 31 inside the housing 11. The liquid supply section 31 is provided, for example, on a side of the second width direction X2 with respect to the support section 29. The liquid supply section 31 may be provided along an inner wall surface with respect to the left side surface 14. The liquid supply section 31 is configured to accommodate liquid and supply the accommodated liquid to the print head 33. The liquid supply section 31 may be a detachable cartridge type, or may be a tank type in which the liquid can be replenished. A top surface of the liquid supply section 31 may be planar.

In addition, the housing 11 can be provided with a cover 18 so that the liquid supply section 31 can be taken in and out, for example, from the front surface 12 side of the housing 11. In addition, the opening/closing detection section 107 to be described later may be configured to detect opening and closing of the cover 18.

In addition, the printing apparatus 100 includes a printing section 105 configured to perform printing on the medium supported by the support section 29. The printing section 105 performs printing by forming an image indicated by print data of a print target on the medium.

The print head 33 is mounted on the printing apparatus 100 as a portion of the printing section 105. The print head 33 can eject liquid onto the medium supported by the support section 29. The print head 33 includes a plurality of nozzles (not shown) capable of ejecting liquid. The print head 33 includes a nozzle surface (not shown) in which the plurality of nozzles are opened. The nozzle surface is a surface facing the lower side Z2.

The printing section 105 includes a carriage 34. The carriage 34 is configured to support the print head 33. The print head 33 is configured as a serial type. In the serial type, the print head 33 performs printing while moving in the width direction X.

The printing section 105 includes a head moving section 35. The head moving section 35 is configured to move the carriage 34. That is, the head moving section 35 is configured to move the print head 33. The head moving section 35 is configured to move the print head 33 in a horizontal direction. Although a detailed description of a mechanism for moving the print head 33 in the X direction and the Y direction by the head moving section 35 is omitted, the head moving section 35 may be configured to move the print head 33 in the width direction X and the front-rear direction Y.

As described above, the head moving section 35 mounts the print head 33 and is movable in the horizontal direction across the support section 29. Although a portion of the head moving section 35 is not shown, the head moving section 35 is configured in a portal shape in a front view. That is, the printing apparatus 100 is a gantry-driven printing apparatus which moves the print head 33 using a portal structure (gantry) and realizes precise and high-quality printing.

The head moving section 35 can move the print head 33 within a movement range. The movement range of the print head 33 includes a facing position and a retracted position. The facing position is a position at which the nozzle surface of the print head 33 faces the support section 29. The retracted position is a position at which the nozzle surface of the print head 33 does not face the support section 29. The retracted position includes a standby position. The standby position is a position at which the print head 33 is disposed when printing is not performed. The standby position may be located on the first width direction X1 side and on the rear side Y2 within the movement range. The retracted position includes a maintenance position. The maintenance position is a position at which the nozzle surface of the print head 33 faces a maintenance section 40 described below. That is, the movement range of the print head 33 includes the maintenance position.

Further, the printing apparatus 100 can include the maintenance section 40. The maintenance section 40 is provided, for example, on a side of the first width direction X1 with respect to the support section 29. The maintenance section 40 is configured to extend in the front-rear direction Y. The maintenance section 40 is disposed at a position that does not overlap the support section 29 and a medium accommodation section 30 in the vertical direction Z. The maintenance section 40 is disposed at a position capable of facing the print head 33 toward the upper side Z1. The maintenance section 40 is configured to perform maintenance of the print head 33.

The maintenance section 40 may include a flushing section (not shown) configured to receive the liquid ejected from the print head 33. The flushing section is configured to be movable in the front-rear direction Y together with the print head 33, but may be configured to extend along the front-rear direction Y.

The maintenance section 40 can include a wiping section (not shown) configured to wipe the nozzle surface. The wiping section 42 is disposed at a position that does not overlap the support section 29 in the vertical direction Z.

The maintenance section 40 may include a suction section (not shown) configured to suck liquid from the print head 33. The suction section may include a suction pump that sucks liquid from the print head 33. The suction section is disposed at a position that does not overlap the support section 29 in the vertical direction Z.

Further, the maintenance section 40 can include a cover 44 that covers so as to hide the brushing section, the wiping section, and the suction section when maintenance is not performed. As shown in FIG. 1, the cover 44 is a cover that can cover the upper side Z1 of the maintenance section 40. In addition, the maintenance section 40 can include a cover accommodation section 45 configured to be able to accommodate the cover 44 when performing maintenance. The cover accommodation section 45 is provided between the support section 29 and the maintenance section 40 in the width direction X.

As described above, the cover 44 is movable between the cover position shown in FIG. 1 and an accommodating position (not shown). The cover position is a position at which the upper side Z1 side of the maintenance section 40 is covered. The accommodating position is a position in which the upper side Z1 side of the maintenance section 40 is not covered and in which accommodation in the cover accommodation section 45 is performed.

In addition, the opening/closing detection section 107 to be described later may be configured to detect opening and closing of the cover 44. In this example, the open state of the cover 44 refers to a state in which the cover 44 is accommodated in the cover accommodation section 45, but may include a state before the cover 44 is accommodated in the cover accommodation section 45 as long as the cover 44 is not in a closed state.

In addition, the maintenance section 40 may include, for example, a waste liquid tank (not shown) on the inner side of a cover 19 provided on the front surface 12 side. The waste liquid tank is configured to store the liquid received by the flushing section. The waste liquid tank is configured to store the liquid sucked by the suction section. The waste liquid tank can be configured to be removable from the cover 19, but need only be disposed at a position that does not overlap the support section 29 in the vertical direction Z. The waste liquid tank may be referred to as a waste liquid box. In addition, the opening/closing detection section 107 to be described later may be configured to detect opening and closing of the cover 19.

The printing apparatus 100 includes a configuration that enables printing even on a medium having a non-planar printing region that requires distance information between the medium and the support section 29 at the time of printing execution. That is, the printing apparatus 100 includes a configuration capable of printing even on a medium having a non-planar image formation surface, such as, for example, a ball, three-dimensional clothing, a doll, and the like, as well as on a medium having a planar image formation surface such as paper or a sheet.

Therefore, the printing apparatus 100 includes the distance detection section 106 that detects the above-described distance between the support section 29 and the medium, and uses the distance for printing control. The printing apparatus 100 has at least a printing function of performing printing in accordance with a set distance to a medium, and produces a printed matter. Although a printing method in the printing section 105 is not limited, for example, an ink jet printing method capable of printing on a non-planar surface is normally used. The printing apparatus 100 may be referred to as a printer or an image forming apparatus.

In FIG. 1, for convenience, an example in which only four distance detection sections 106 are provided in the support section 29 is shown, but the distance detection sections 106 may be disposed to detect the above-described distance at respective points so as to cover the printing region of the medium. A method of detecting a distance in the distance detection section 106, that is, a distance measurement method is not limited, but can be configured with an optical distance measurement sensor.

The print head 33 described above performs printing on the medium based on the distance between the print head 33 and the support section 29. This distance is the distance detected by the distance detection section 106. This distance may be referred to as a medium height.

However, the distance between the print head 33 and the support section 29 may be a distance set by a user at respective points in the printing region and the like. In order to enable a user operation including such a setting operation, the housing 11 can include a user interface (UI) section 104 including a display section and an operation section.

The display section in the UI section 104 is configured to display a UI image. The display section includes, for example, a display device such as a liquid crystal display or an organic electroluminescence display. The display section can include a display and a drive circuit for driving the display. The operation section in the UI section 104 is configured to be operable by the user. The operation section may include a physical button. The display section and the operation section may be integrally configured like a touch panel, or some or all of them may be separately configured. The UI section 104 can be provided on the top surface 16 as shown, but an installation location is not limited thereto, and may be, for example, the front surface 12.

In addition, the printing apparatus 100 includes a control section 101 shown in FIG. 2, which will be described below. The disposition of the control section 101 is not limited, as long as the control section 101 is disposed in the housing 11. The printing apparatus 100 is configured to control the movement of the print head 33 and control ejection of the liquid from the print head 33 based on the above-described distance under the control of the control section 101, thereby printing an image indicated by the print data of the print target on the medium supported by the support section 29.

As described above, the printing apparatus 100 is a gantry-driven printing apparatus that requires a medium height parameter during printing control and involves opening and closing of a cover exemplified by the first cover 24 when the medium is set. The printing apparatus 100 is a direct to garment (DTG) printer that performs printing directly on clothes, shoes, or the like, a UV printer that can perform printing on various materials such as accessories, wood, glass, metal, and plastic using UV curable ink, or the like. DTG is an abbreviation for direct to garment. UV is an abbreviation for ultra violet.

In addition, the printing apparatus 100 may include a copy function that detects a distance between the support section and a medium as a printed matter, optically reads an image on the medium, and performs, for a newly supported medium, distance detection and printing based on the detection result, that is, copying.

### Functional Configuration Example of Printing Apparatus

Next, functions including such control of the printing apparatus 100 will be described with reference to FIG. 2. FIG. 2 is a functional block diagram showing a configuration example of the printing apparatus 100.

As shown in FIG. 2, the printing apparatus 100 can include the control section 101, the storage section 102, the communication section 103, the UI section 104, the printing section 105, the distance detection section 106, and the opening/closing detection section 107. Hereinafter, each section of the printing apparatus 100 will be described. The UI section 104 and the printing section 105 are the same as those described with reference to FIG. 1, and a description thereof will be omitted.

The control section 101 controls the entirety of the printing apparatus 100. The control section 101 can be configured with, for example, an arithmetic processing device, a work memory, and a storage device that stores a control program, a parameter, and the like. The arithmetic processing device can be a central processing unit (CPU), a graphics processing unit (GPU), or the like. The arithmetic processing device can be referred to as a processor. The control section 101 can be configured as a system on a chip (SoC). As can be understood from these examples, the control section 101 can be configured to store the control program in an executable state. Meanwhile, the control section 101 can be configured to store a portion of the control program as a circuit configuration such as a field-programmable gate array (FPGA), or may be configured as a dedicated circuit.

The above-described control program can include a program for executing processing related to printing while the arithmetic processing device cooperates with the storage section 102, the communication section 103, the UI section 104, the printing section 105, the distance detection section 106, and the opening/closing detection section 107. At least a portion of the control program can be included in the control section 101, but may be stored in the storage section 102 provided separately from the control section 101.

The storage section 102 is, for example, a hard disk drive, a solid state drive, or another storage device using a memory. The storage section 102 can store various kinds of data such as data related to various settings related to printing and intermediate data at the time of printing.

The communication section 103 is a section that communicates with an external device such as a terminal device or a server device in a wireless or wired manner via a network in accordance with a predetermined communication standard. The communication section 103 can be configured with one or a plurality of communication interfaces that can perform such communication. The network is typically the Internet or an intranet, including a local area network (LAN). The communication section 103 may include a configuration in which the communication section 103 is directly connected to a terminal device and performs communication without using a network.

The above-described terminal device is an information processing apparatus having a communication function, such as a personal computer (PC), a smartphone, or a tablet terminal, and can be used by a user who wants to perform printing. The terminal device performs processing of transmitting a print request, performs setting operations for printing, and is connected to the printing apparatus 100 via the network. The above-described server device may be a server computer that provides a print service, or may be a cloud server.

The distance detection section 106 detects the distance between the medium and the support section 29 when the first cover 24 is closed. For example, when the control section 101 receives, from the opening/closing detection section 107 to be described later, information indicating that the first cover 24 is closed, the control section 101 instructs the distance detection section 106 to detect the distance, thereby enabling detection at such timing. By executing distance detection in this way, distance detection can be executed regardless of whether or not print data is received, and thus printing can be performed efficiently.

The opening/closing detection section 107 includes a sensor that detects opening and closing of the first cover 24 and passes a detection result to the control section 101. As long as opening/closing detection of the first cover 24 is possible, the disposition and the detection method of the sensor are not limited. In addition, the opening/closing detection section 107 may include a sensor that detects opening and closing of each of the cover 18, the cover 44, and the cover 19 described above and passes a detection result to the control section 101. However, the opening/closing detection section 107 may be configured not to perform at least one of the detection of the opening and closing of the cover 18 and the detection of the opening and closing of the cover 19. This is because distance detection is possible regardless of an open/closed state of each of the cover 18 and the cover 19.

In addition, although not shown, the printing apparatus 100 may include a medium detection section which detects a medium on the support section 29 and passes a detection result to the control section 101. Accordingly, even when the first cover 24 is closed, the control section 101 can control so as to execute distance detection processing only when the medium is detected by the medium detection section. The medium detection section can be substituted by the distance detection section 106, but can be provided in the housing 11 separately from the distance detection section 106. For example, the medium detection section can be a sensor disposed at a position obliquely above the support section 29, or a sensor disposed so that detection light crosses over the support section 29.

However, the printing apparatus 100 may not include the medium detection section. For example, the UI section 104 may accept a user operation indicating that the medium is mounted on the support section 29 by the user or a user operation instructing the start of the distance detection processing. By receiving acceptance of such a user operation from the UI section 104, the control section 101 may determine that the medium is mounted and start the distance detection processing. Alternatively, the control section 101 may start the distance detection processing on the premise that the medium is always mounted on the support section 29.

### Effects of Present Embodiment

Before describing a more specific example of printing processing in the present embodiment, effects of the present embodiment will be described.

In the printing apparatus 100, efficient printing is enabled even on a medium having a non-planar printing region that requires distance information between the medium and the support section 29 at the time of printing execution.

In order to supplement the effects, the printing apparatus according to the present embodiment is compared with a printing apparatus according to a comparative example. In the printing apparatus according to the comparative example, the user mounts the medium on a printing apparatus main body, transmits print data from a PC to the printing apparatus, and then presses a print start button on an operation panel provided in or coupled to the printing apparatus main body to start distance detection. In the comparative example, since distance detection starts at such timing, the printing apparatus performs no processing during a period from mounting the medium until pressing the print start button due to preparation of print data, data transmission operation, and the like by the user, thereby resulting in wasted time.

On the other hand, in the printing apparatus 100, the above-described distance detection can be executed regardless of whether or not print data is received, and the above-described distance can be detected using, as a trigger, that the medium has been mounted and the first cover 24 has been closed. Therefore, in the printing apparatus 100, the time required from mounting of the medium, that is, from setting of the medium, to completion of printing can be shortened without requiring wasted time as in the comparative example, and printing can be efficiently executed.

In addition, in the printing apparatus 100, since a distance between the medium and the support section 29 is automatically detected at the time of setting of the medium, after setting of the medium, the user is enabled to prepare print data, replace consumables such as ink, and perform maintenance work of a type that does not hinder detection of the above-described distance. As a result, in the printing apparatus 100, a total time required for printing can be shortened, and production of a larger number of printed matters is enabled.

In addition, since the printing apparatus 100 includes the cover of the printing apparatus 100 as exemplified by the first cover 24 and the cover 44, it is possible to easily perform maintenance. The maintenance mentioned here is not limited to the maintenance using the maintenance section 40, and can include, for example, cleaning of the inside of the housing 11 including the support section 29.

### Processing Example in Printing Apparatus

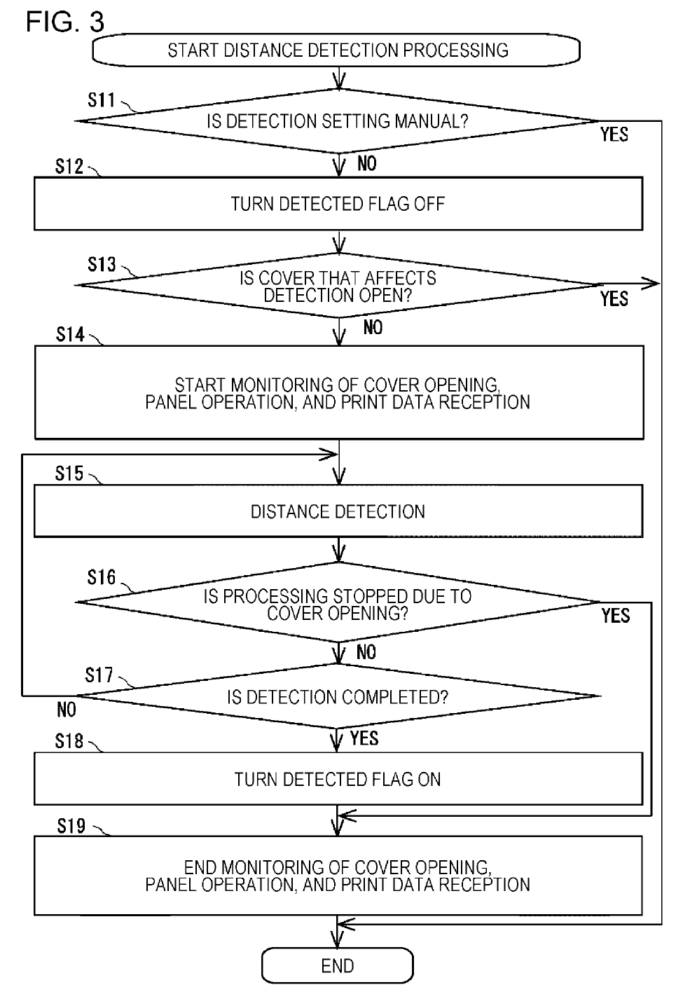

A processing example in the printing apparatus 100 will be described with reference to FIG. 3. FIG. 3 is a flowchart for describing an example of distance detection processing executed in the printing apparatus 100.

When the opening/closing detection section 107 detects that the medium is set and the first cover 24 is closed, the distance detection processing is started when the control section 101 receives the detection result. First, the control section 101 determines whether or not a detection setting is manual (Step S11). When YES is obtained in Step S11, the control section 101 ends the distance detection processing. In this case, the control section 101 controls the printing section 105 to print the print data of the print target on the medium based on the manually set distance.

When NO is obtained in Step S11, the control section 101 turns OFF a detected flag stored in advance in the storage section 102 (Step S12). The detected flag is a flag that is turned ON when the distance has been detected and is set to OFF before detection completion. Next, as an initial state of the distance detection processing, the control section 101 obtains a detection result by the opening/closing detection section 107, and determines whether or not the cover that affects the distance detection is open based on the detection result (Step S13).

The cover that affects the distance detection is a cover other than the first cover 24, and corresponds to, for example, the cover 44 of the maintenance section 40, and does not correspond to the covers 18 and 19 in the structure shown in FIG. 1. In addition, covers that affect distance detection include, in addition to the cover 44, a cover for attaching the print head 33, although not shown. When YES is obtained in Step S13, the control section 101 ends the distance detection processing, and the distance detection section 106 does not detect the distance.

As in this example, the printing apparatus 100 includes an openable/closable second cover which is different from the first cover 24 and affects the distance detection by the distance detection section 106 when the second cover is opened. When the second cover is opened, the distance detection section 106 does not perform distance detection, or stops detection even during distance detection, as will be described later in Step S16.

On the other hand, when NO is obtained in Step S13, that is, when a cover that does not affect the detection processing is opened at the start of distance detection, processing and work related to the cover are enabled, and the distance detection processing is continued. This point is the same even during the distance detection as will be described later in Step S16.

Covers that do not affect distance detection processing include the covers 18 and 19 as described above, and even when these covers are in an open state, liquid replacement by insertion and removal of the liquid supply section 31, that is, ink replacement and insertion and removal of a waste liquid tank, can be performed while distance detection processing is continued. The open/closed states of the covers 18 and 19 may be detected by the opening/closing detection section 107 as described above, and the detection result may be provided to the control section 101. However, the printing apparatus 100 may adopt a configuration in which the detection of the open/closed states of the covers 18 and 19 is not performed or the detection result is not used for the distance detection processing.

In FIG. 1, due to the structure of the printing apparatus 100, opening/closing of the cover 18 and ink replacement do not affect the distance detection processing, but a structure may be adopted in which a cover required for ink replacement affects the distance detection processing, such as a case where ink itself is mounted in the print head 33. In such a structure, when the cover is in the open state, a determination of NO is made in Step S13.

When NO is obtained in Step S13, the control section 101 starts monitoring whether or not the cover is opened, whether or not the operation panel is operated, and whether or not the print data is received (Step S14). Here, whether or not the cover is in the open state is the same as the determination in Step S13.

Next, the control section 101 controls the distance detection section 106 to detect the distance, and the distance detection section 106 detects the distance and passes the detection result to the control section 101 (Step S15). During the distance detection, the control section 101 constantly obtains the monitoring result of Step S14, and determines whether or not to stop the distance detection processing when the cover is opened (Step S16). As described for Step S13, in Step S16, YES is determined when the cover that affects the detection of the distance is in the open state.

When NO is obtained in Step S16, the control section 101 determines whether or not the distance detection section 106 has completed the distance detection (Step S17). When NO is obtained in Step S17, the control section 101 may return to Step S15 and cause the distance detection section 106 to continue the distance detection. When YES is obtained in Step S17, the control section 101 turns ON the detected flag (Step S18). Following Step S18, the control section 101 ends the monitoring in Step S14 (Step S19), and ends the distance detection processing.

On the other hand, when YES is obtained in Step S16, the control section 101 ends the monitoring in Step S14 (Step S19), and ends the distance detection processing.

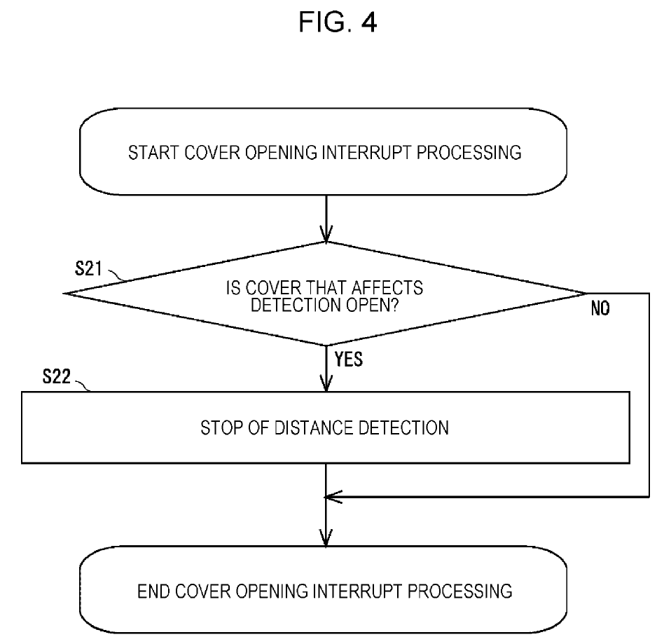

Next, an example of cover opening interrupt processing executed in parallel with the distance detection processing of FIG. 3 will be described with reference to FIG. 4. FIG. 4 is a flowchart showing an example of the cover opening interrupt processing executed in the printing apparatus 100.

The cover opening interrupt processing is executed based on the monitoring result of the cover open state in Step S14. First, as described in Step S13, the control section 101 determines whether or not the cover that affects the distance detection is in the open state (Step S21). When YES is obtained in Step S21, as described in Step S16, the control section 101 causes the distance detection section 106 to stop the distance detection (Step S22), and ends the processing. On the other hand, in the case of NO in Step S21, the control section 101 ends the cover opening interrupt processing.

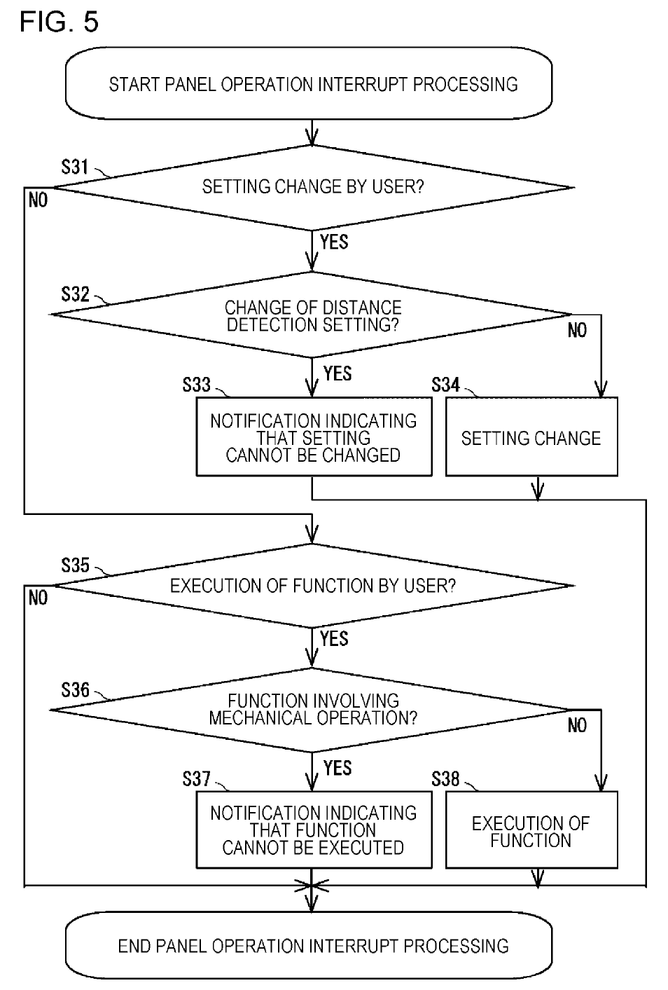

Next, an example of panel operation interrupt processing executed in parallel with the distance detection processing of FIG. 3 will be described with reference to FIG. 5. FIG. 5 is a flowchart for describing an example of panel operation interrupt processing executed in the printing apparatus 100.

The panel operation interrupt processing is executed based on the monitoring result of the panel operation in Step S14. First, the control section 101 determines whether or not the UI section 104 has accepted a setting change operation by the user (Step S31).

When YES is obtained in Step S31, the control section 101 determines whether or not the setting change is a setting change relating to distance detection (Step S32). Changes to the corresponding settings may include a change in which a distance is manually set without performing distance detection. Manually setting the distance can refer to setting performed by a user by manually inputting distance data via the UI section 104 of the printing apparatus 100 or by transmitting the distance data via an external terminal device. Setting changes that result in NO in Step S31 include, for example, settings as to whether printing is performed in monochrome or in color, and settings of printing fineness.

When YES is obtained in Step S32, the control section 101 displays, on the UI section 104, a UI image including a notification indicating that the setting cannot be changed (Step S33), and ends the panel operation interrupt processing. In this case, the control section 101 or the UI section 104 does not accept the target setting change. This UI image may be displayed by transition from the UI image for various settings by the user in the UI section 104 or by adding a pop-up image to the UI image for various settings. On the other hand, when NO is obtained in Step S32, the control section 101 executes the setting change in accordance with the operation of the setting change by the user (Step S34), and ends the panel operation interrupt processing.

As shown in steps S31 to S34, the printing apparatus 100 may include an operation receiving section that receives a user operation including manual setting of distances, which is shown in the UI section 104. The operation receiving section may be configured not to receive the manual setting of the distance based on the user operation while the distance detection section 106 detects the distance.

On the other hand, when NO is obtained in Step S31, the control section 101 determines whether or not a certain function of the printing apparatus 100 has been executed by the user (Step S35). Next, the control section 101 determines whether or not the function is a function involving a mechanical operation (Step S36). The function involving a mechanical operation refers to a function involving an operation such as movement or rotation of a physical member. For example, functions such as head cleaning and flushing correspond to functions involving mechanical operations. On the other hand, for example, cleaning other than the print head 33, ink replacement, waste liquid replacement, and the like correspond to functions that do not involve mechanical operations.

In Step S36, basically, whether or not the function affects distance detection is determined, and therefore, even if the function involves a mechanical operation, NO may be obtained in Step S36. However, when a mechanical operation is performed, the distance detection accuracy decreases due to the vibration. Therefore, all mechanical operations may be regarded as affecting distance detection.

When YES is obtained in Step S36, the control section 101 displays, on the UI section 104, a UI image including a notification indicating that the designated function cannot be executed (Step S37), and ends the panel operation interrupt processing. In this case, the control section 101 or the UI section 104 does not accept execution of the target function. This UI image may be displayed by transition from the UI image for various settings by the user in the UI section 104 or by adding a pop-up image to the UI image for various settings. On the other hand, when NO is obtained in Step S36, the control section 101 executes the designated function by controlling another portion that realizes the function (Step S38), and ends the panel operation interrupt processing. The order of the processing in steps S31 to 34 and the processing in steps S35 to S38 may be reversed.

As shown in steps S31 to S34, the printing apparatus 100 may include an operation receiving section that receives a user operation shown in the UI section 104. While the distance detection section 106 is detecting the distance, the operation receiving section does not receive a user operation for executing a function involving an operation of a physical member among functions installed in the printing apparatus 100. The operation of the physical member refers to an operation of a mechanical member as described above, and can refer to an operation involving a change in the position, orientation, or the like of a member with respect to a reference member serving as a reference such as a housing.

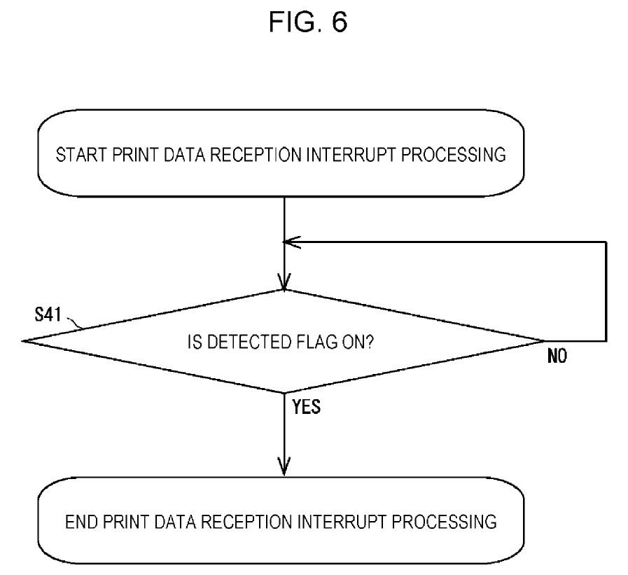

Next, an example of print data reception interrupt processing executed in parallel with the distance detection processing of FIG. 3 will be described with reference to FIG. 6. FIG. 6 is a flowchart for describing an example of print data reception interrupt processing executed in the printing apparatus 100.

The print data reception interrupt processing is executed based on the monitoring result of the print data reception in Step S14. First, the control section 101 determines whether or not the detected flag is ON (Step S41). When YES is obtained in Step S41, the print data reception interrupt processing is ended. On the other hand, when NO is obtained in Step S41, the control section 101 waits until YES is obtained in Step S41. That is, the control section 101 waits until the distance detection processing is completed in the subsequent processing when the print data is received.

In this way, when the print data is input during the execution of the distance detection by the distance detection section 106, the control section 101 may perform control such that the distance detection section 106 continues the detection of the distance and does not start printing. When the print data is input at such a timing, the control section 101 may perform control such that the print head 33 performs printing of the print data after ending the distance detection. The input of the print data, that is, the reception of the print data can be realized by providing the printing apparatus 100 with an input section for inputting the print data to be printed by the print head 33 as exemplified by the communication section 103. The input section may be an input interface for reading data from a computer-readable portable recording medium.

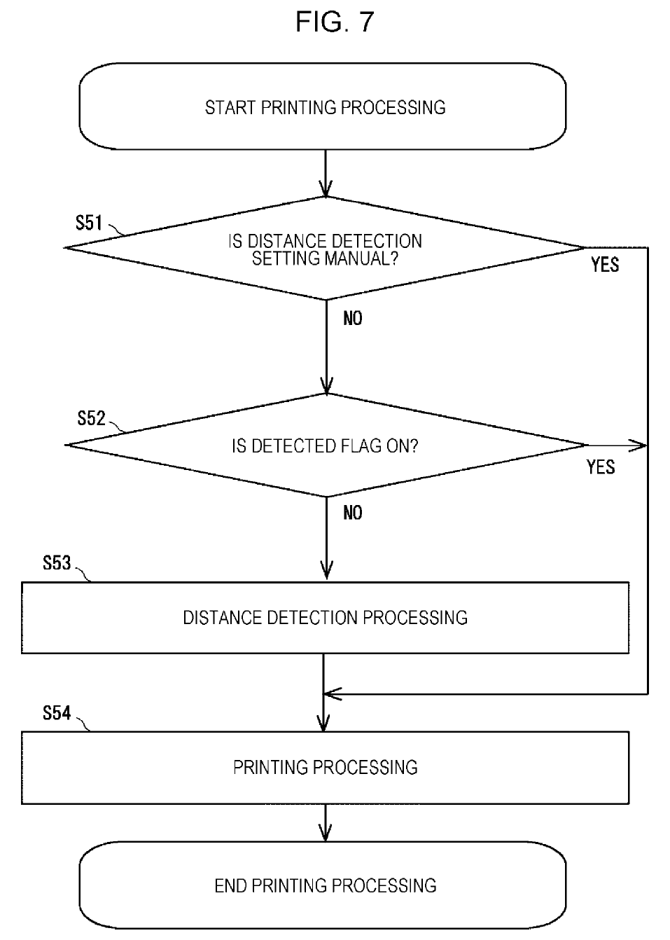

Next, an example of printing processing executed after the distance detection processing of FIG. 3 will be described with reference to FIG. 7. FIG. 7 is a flowchart for describing an example of printing processing executed in the printing apparatus 100.

First, the control section 101 determines whether or not distance detection setting is manual (Step S51). When NO is obtained in Step S51, the control section 101 determines whether or not the detected flag is ON (Step S52).

When NO is obtained in Step S52, the control section 101 executes the distance detection processing described in FIG. 3 (Step S53). Next, the control section 101 controls the printing section 105 so as to perform printing on the medium based on the distance detected in the distance detection processing for print data to be printed, whereby the printing section 105 executes printing (Step S54). After the processing of Step S54, the printing processing is completed. Further, when YES is obtained in Step S51 and when YES is obtained in Step S52, the process proceeds to Step S54 in either case and the printing processing is executed.

### Other Modification Examples

The present disclosure is not limited to the embodiments described above, and can be appropriately changed without departing from the gist. For example, the configurations of the printing apparatus, the terminal device, and the server device, the configurations of the programs included in the respective apparatuses, the processing procedures of the respective apparatuses, and the like are not limited to those exemplified.

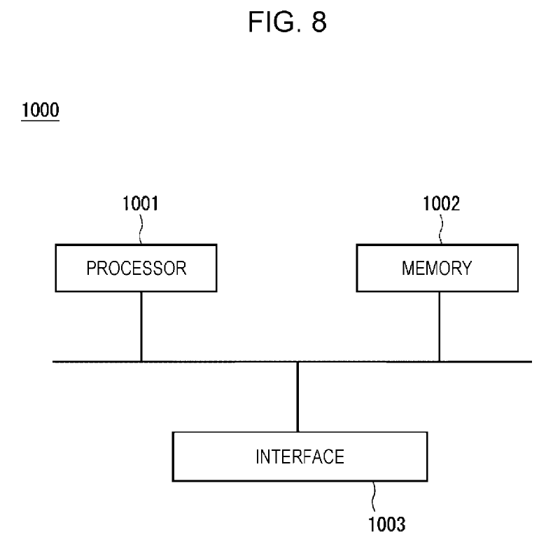

In addition, each device according to the above-described embodiments may include, for example, the following hardware configuration. FIG. 8 is a diagram showing an example of the hardware configuration of a device.

A device 1000 shown in FIG. 8 may include a processor 1001, a memory 1002, and an interface 1003. The interface 1003 may include, for example, interfaces required depending on the device, such as a communication interface and interfaces with input and output devices.

The processor 1001 may be, for example, a CPU, a GPU, or a Micro Processor Unit (MPU), which is also referred to as a microprocessor. The processor 1001 may include a plurality of processors. The memory 1002 is configured with, for example, a combination of a volatile memory and a non-volatile memory. A function of each device is realized by the processor 1001 reading a program stored in the memory 1002 and executing the program while exchanging necessary information via the interface 1003.

In addition, the program described above includes a group of commands (or software code) for causing a computer to perform one or more functions described in the embodiment when the program is read by the computer. The program may be stored in a non-transitory computer-readable medium or a tangible storage medium. By way of non-limiting example, the computer-readable medium or the tangible storage medium includes a random-access memory (RAM), a read-only memory (ROM), a flash memory, a solid-state drive (SSD), or another memory technology. By way of non-limiting example, the computer-readable medium or the tangible storage medium includes a CD-ROM, a digital versatile disc (DVD), a Blu-ray (registered trademark) disk or another optical disk storage, a magnetic cassette, a magnetic tape, a magnetic disk storage, or another magnetic storage device. The program may be transmitted on a transitory computer-readable medium or a communication medium. By way of non-limiting example, the transitory computer-readable medium or the communication medium includes electrical, optical, acoustical, or other forms of propagated signals.

The present disclosure is described above with reference to the embodiments. However, the present disclosure is not limited to the configurations of the embodiments, and it is needless to say that various modifications, amendments, and combinations that can be made by those skilled in the art are included within the scope of the claims of the present disclosure.

What is claimed is:

1. A printing apparatus comprising:
a housing having an openable/closable first cover;
a support section configured to support a medium;
a print head configured to perform printing on the medium based on a distance between the print head and the support section; and
a distance detection section configured to detect the distance, wherein
the distance detection section executes detection of the distance when the first cover is closed.

2. The printing apparatus according to claim 1, further comprising:
an openable/closable second cover which is different from the first cover and which affects the detection of the distance by the distance detection section when the second cover is opened, wherein
the distance detection section stops the detection of the distance when the second cover is opened.

3. The printing apparatus according to claim 1, further comprising:
an operation receiving section configured to receive a user operation including a manual setting of the distance, wherein
the operation receiving section does not receive the manual setting of the distance based on the user operation while the distance detection section is executing the detection of the distance.

4. The printing apparatus according to claim 1, further comprising:
an operation receiving section configured to receive a user operation, wherein
the operation receiving section does not receive, among the user operations, a user operation for executing a function involving an operation of a physical member among functions installed in the printing apparatus while the distance detection section is executing the detection of the distance.

5. The printing apparatus according to claim 1, further comprising:
an input section configured to input print data to be printed by the print head, wherein
when the print data is input while the distance detection section is executing the detection of the distance, the distance detection section continues the detection of the distance, and the print head executes the printing of the print data after ending the detection of the distance.

6. A printing method comprising:
executing, by a printing apparatus including a housing having an openable/closable first cover, a support section configured to support a medium, and a print head configured to perform printing on the medium based on a distance between the print head and the support section, detection of the distance when the first cover is closed.
